(19) United States
(12) Patent Application Publication
(10) Pub. No.: US 2013/0070105 A1
(43) Pub. Date: Mar. 21, 2013

(54) TRACKING DEVICE, TRACKING METHOD, AND COMPUTER PROGRAM PRODUCT

(71) Applicants: Tsukasa Ike, Tokyo (JP); Ryuzo Okada, Kanagawa (JP); Hidetaka Ohira, Tokyo (JP)

(72) Inventors: Tsukasa Ike, Tokyo (JP); Ryuzo Okada, Kanagawa (JP); Hidetaka Ohira, Tokyo (JP)

(73) Assignee: KABUSHIKI KAISHA TOSHIBA, Tokyo (JP)

(21) Appl. No.: 13/537,354

(22) Filed: Jun. 29, 2012

(30) Foreign Application Priority Data
Sep. 15, 2011 (JP) 2011-202408

(51) Int. Cl. H04N 5/225; G06K 9/00

(52) U.S. Cl. 348/169; 382/103; 348/E05.024

(57) ABSTRACT

According to an embodiment, a tracking device includes an acquiring unit, a first calculator, a second calculator, and a setting unit. The acquiring unit images a tracking target object to time-sequentially acquire an image. The first calculator calculates a first likelihood representing a degree of coincidence between a pixel value of each pixel included in a search region within the image and a reference value. The second calculator calculates a difference value between the pixel value of each pixel in the search region and the pixel value of a corresponding pixel in an image in a past frame. The setting unit sets weights of the first likelihood and the difference value so that as a distance between each pixel in the search region and a position of the tracking target object in the past increases, the weight of the first likelihood decreases and the weight of the difference value increases.

### CROSS-REFERENCE TO RELATED APPLICATION(S)

This application is based upon and claims the benefit of priority from Japanese Patent Application No. 2011-202408, filed on Sep. 15, 2011; the entire contents of which are incorporated herein by reference.

### FIELD

Embodiments described herein relate generally to a tracking device, a tracking method, and a computer program product.

### BACKGROUND

In the related art, a technique of tracking a position of an object within an image with a high recognition rate has been known. In order to prevent false recognition of objects of similar colors and increase a recognition rate, an object position tracking method capable of preventing false recognition of a plurality of regions of predetermined colors as one large region of a predetermined color by providing an upper limit value to a rectangular search region has been known.

However, in the above technique, when a blur occurs in an obtained image due to the movement of a target object, the maximum value of a probability distribution is not observed around the position on the probability distribution corresponding to the target object. As a result, tracking of the target object fails.

### BRIEF DESCRIPTION OF THE DRAWINGS

FIG. 1 is a block diagram illustrating a tracking device according to a first embodiment;

FIG. 2 is a diagram illustrating a configuration example of a generating unit;

FIG. 3 is a flowchart illustrating an example of a processing operation performed by the tracking device according to the first embodiment;

FIG. 4 is a block diagram illustrating a tracking device according to a second embodiment;

FIG. 5 is a diagram illustrating an example of a method of calculating a second likelihood;

FIG. 6 is a flowchart illustrating an example of a processing operation performed by the tracking device according to the second embodiment;

FIG. 7 is a block diagram illustrating a tracking device according to a modification example of the second embodiment;

FIG. 8 is a diagram illustrating correction by a second correcting unit;

FIG. 9 is a block diagram illustrating a tracking device according to a third embodiment;

FIG. 10 is a flowchart illustrating an example of a processing operation performed by the tracking device according to the third embodiment;

FIG. 11 is a block diagram illustrating a tracking device according to a modification example of the third embodiment; and

FIG. 12 is a flowchart illustrating an example of a processing operation performed by the tracking device according to the third embodiment.

### DETAILED DESCRIPTION

According to an embodiment, a tracking device includes an acquiring unit, a first calculator, a second calculator, a first setting unit, a third calculator, a detector, and a determining unit. The acquiring unit is configured to image a tracking target object to acquire an image in units of time-sequential frames. The first calculator is configured to calculate a first likelihood representing a degree of coincidence between a pixel value of each of pixels included in a search region within the image, in which the tracking target object is to be searched for and a reference value representing a feature of the tracking target object. The second calculator is configured to calculate a difference value representing a difference between the pixel value of each of the pixels in the search region and the pixel value of a corresponding pixel in an image of a frame of the past. The first setting unit is configured to set weights of the first likelihood and the difference value so that as a distance between each of the pixels in the search region and a position of the tracking target object in the past increases, the weight of the first likelihood decreases and the weight of the difference value increases. The third calculator is configured to calculate an integrated likelihood of each of the pixels in the search region by weight the first likelihood and the difference value with the weights and adding the weighted first likelihood and difference value. The detector is configured to detect a position of a pixel whose integrated likelihood exhibits a local maximum value among the pixels in the search region as a candidate position of the tracking target object. The determining unit is configured to determine the position of the tracking target object from the candidate position based on a predetermined criterion.

Hereinafter, various embodiments will be described in detail with reference to the accompanying drawings.

### First Embodiment

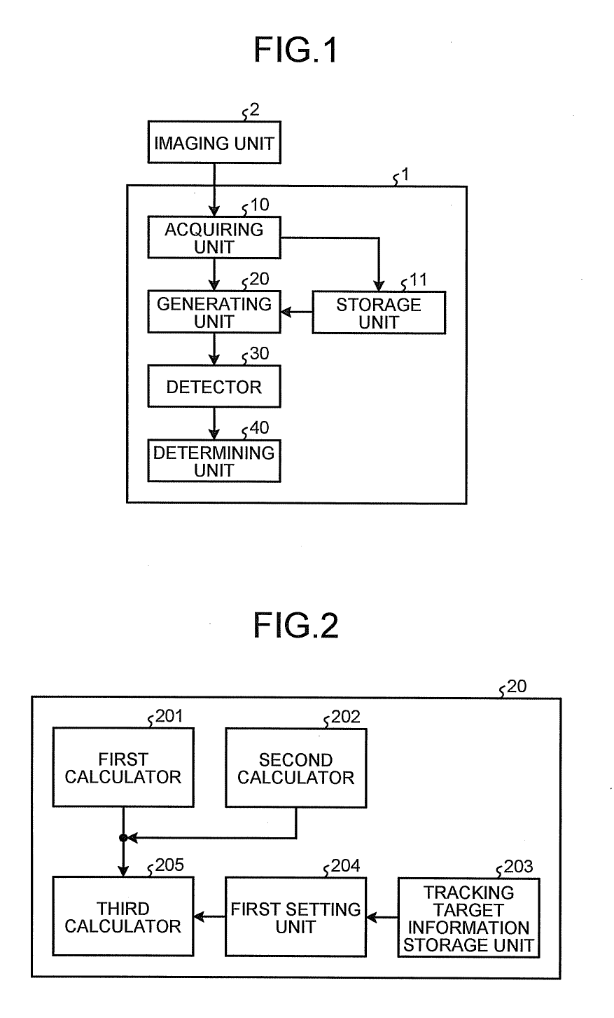

FIG. 1 is a block diagram illustrating a configuration example of a tracking device 1 according to a first embodiment. The tracking device 1 is a device that tracks the position of a tracking target object using an image obtained by an imaging unit 2. In the following description, a case where the hand of a person (user) is a tracking target object will be described as an example. As illustrated in FIG. 1, the tracking device 1 is configured to include an acquiring unit 10, a storage unit 11, a generating unit 20, a detector 30, and a determining unit 40.

The acquiring unit 10 sequentially acquires an image (the unit of each image is also referred to as a “frame”) captured by the imaging unit 2 at a predetermined interval (frame cycle). The imaging unit 2 is configured to include an imaging device such as a CMOS image sensor. The storage unit 11 stores therein the images acquired by the acquiring unit 10.

Each time an image is acquired by the acquiring unit 10, the generating unit 20 generates an integrated likelihood used for determining whether a tracking target object is present at the position of each of the pixels included in a search region which is a region within the acquired image, in which the tracking target object is to be searched for. The generating unit 20 is described in detail below.

FIG. 2 is a block diagram illustrating an example of a detailed configuration of the generating unit 20. As illustrated in FIG. 2, the generating unit 20 includes a first calculator 201, a second calculator 202, a tracking target information storage unit 203, a first setting unit 204, and a third calculator 205.

Each time an image is acquired by the acquiring unit 10, the first calculator 201 calculates, for each of the pixels in the search region of the acquired image, a first likelihood representing the degree of coincidence between a pixel value representing the feature of the pixel and a reference value representing the feature of a tracking target object. In the first embodiment, the first calculator 201 sets a predetermined range around the presence position of a “hand”, which is a tracking target object, in a frame of the past within the image acquired by the acquiring unit 10 as the “search region”. Moreover, in the first embodiment, a color value representing the color of a pixel is employed as a pixel value, and a color distribution of the tracking target object is employed as the reference value.

The first calculator 201 extracts the color value representing the color of each of the pixels in the above-described search region. Moreover, the first calculator 201 calculates, for each of the pixels in the search region, a skin color likelihood representing the degree of coincidence between the color of the pixel and the color of the hand of a person which is the tracking target as the first likelihood. In this example, although the color of each pixel is expressed by a YUV color component, the color expression is not limited to this, and a method of expressing the color of each pixel is optional. For example, the color of each pixel may be expressed by an RGB color component. Moreover, processing such as Gaussian filtering may be performed on the skin color likelihood of each of the pixels in the search region so as to make it easy to track a skin color region having a large area.

The skin color likelihood may be calculated, for example, using a covariance matrix which is generated from the YUV values of a plurality of skin color pixels collected in advance from the image of the hand of a person. The skin color pixels used for generating the covariance matrix may be collected, for example, by a detector detecting the image of a palm of a person presented to the imaging unit 2, detecting the region of a palm from the input image, and collecting a predetermined range of pixels within the region. In this way, the covariance matrix may be automatically generated in accordance with an individual difference in the skin color of persons. However, the covariance matrix generating method is not limited to this, and for example, the covariance matrix may be generated offline in advance from the skin color pixels of various persons and used. Alternatively, a skin color region may be designated manually with respect to an input image, and the covariance matrix may be generated using the pixels within the designated region. In addition, the skin color likelihood may be understood as the degree of coincidence between the color value of a pixel and the central color value of a color distribution of a tracking target object. In this case, the central color value of the color distribution of the tracking target object may be understood as the reference value.

The second calculator 202 calculates, for each of the pixels in the above-described search region, a difference value representing a difference between the pixel value (in this example, a color value) of the pixel in the search region and the pixel value of the corresponding pixel in an image of a past frame. In the first embodiment, each time an image is acquired by the acquiring unit 10, the second calculator 202 extracts the pixel value of each of the pixels in the search region of the acquired image and reads the pixel value of the corresponding pixel in an image of a previous frame from the storage unit 11. Moreover, the second calculator 202 calculates, for each of the pixels in the search region, an absolute value of a difference between the pixel value of the pixel in the search region and the pixel value of the corresponding pixel in an image of a previous frame, as a difference value. In addition, the image of a frame of the past read from the storage unit 11 when calculating the difference value is not limited to the image of a previous frame. Here, processing such as Gaussian filtering may be performed on the difference value of each pixel in the search region so as to make it easy to track a region having a significant movement.

The difference value of each pixel in the search region is obtained by calculating, for each of the YUV components of each pixel, the absolute value of a difference from the pixel value of the previous frame and adding these absolute values. However, as a countermeasure to a difference value observed even when a tracking target and other objects do not move due to the influence of image noise, when a predetermined offset value set in advance is subtracted from the calculated difference value and the result of subtraction has a negative value, the difference value may be regarded as 0. Alternatively, the difference value may be calculated after removing noise by performing filtering on the input image.

The tracking target information storage unit 203 stores therein information on the position and size and the like of the tracking target object in frames of the past. The first setting unit 204 sets weights of the first likelihood and the difference value for each of the pixels in the above-described search region. The third calculator 205 calculates an integrated likelihood of each of the pixels in the search region by weight the skin color likelihood and the difference value with the weights set by the first setting unit 204 and adding the weighted skin color likelihood and difference value.

In general, when the tracking target object is imaged by an image sensor, a blur is likely to occur in the image of the tracking target object as the moving speed of the tracking target object increases. When a blur occurs in the image of the tracking target object, the components of a background image are mixed into the pixels within a region. As a result, a color different from the original color of the tracking target object is observed, and thus, the skin color likelihood decreases. On the other hand, when the moving speed of the tracking target object increases, the difference value generated by the above-described method increases further. From these facts, it is possible to stably track the tracking target object by weight the skin color likelihood more when the moving speed of the tracking target object is small, and weight the difference value more when the moving speed is large.

On the other hand, the moving speed of the tracking target object appears as a relative length to the size of a hand region based on the position of a hand (the tracking target object) in frames of the past. Therefore, the integrated likelihood generated by integrating the first likelihood and the difference value is calculated by calculating the distance between each of the pixels in the above-described search region and the position of a hand in the frame of the past and adding the skin color likelihood and the difference value while changing the weights thereof in accordance with the calculated distance. By doing so, it is possible to stably perform tracking regardless of the moving speed of the tracking target object. Hereinafter, a specific weight setting method and a specific integrated likelihood calculating method will be described.

The first setting unit 204 sets the weights of the first likelihood and the difference value for each of the pixels in the above-described search region so that as the distance between the pixel and the position of the tracking target object in the frames of the past increases, the weight of the first likelihood (in this example, the skin color likelihood) decreases and the weight of the difference value increases. More specifically, each time an image is acquired by the acquiring unit 10, the first setting unit 204 reads the position of the tracking target object in a frame of the past (for example, the previous frame) from the tracking target information storage unit 203. Moreover, the first setting unit 204 calculates the distance between each of the pixels in the search region of the image acquired by the acquiring unit 10 and the position of the tracking target object in a frame of the past and sets the weights of the skin color likelihood and the difference value in accordance with the calculated distance. For example, when the coordinates of a processing target pixel are (tx, ty), the coordinates of a tracking target object (in this example, a “hand”) in a frame of the past are (px, py), and the size (pixel area) of the tracking target object is “s”, a weight parameter “w” for setting weight is expressed by Expression 1 below.

$$w = exp ( - k \cdot \frac{{( tx - px )}^{2} + {( ty - py )}^{2}}{{ps}^{2}} ) \qquad ( 1 )$$

In this example, the weight parameter w calculated by Expression 1 is set as the weight factor of the skin color likelihood, and (1−w) is set as the weight factor of the difference value. The method of setting the weights of the skin color likelihood and the difference value is not limited to this but is optional. For example, the weights of the skin color likelihood and the difference value may be set so that the weight of the skin color likelihood decreases and the weight of the difference value increases as the distance between each of the pixels in the above-described search region and the position of the tracking target object in the past increases.

The third calculator 205 calculates, for each of the pixels in the search region, the integrated likelihood by weight the skin color likelihood and the difference value with the weights set by the first setting unit 204 and adding the weighted first likelihood and difference value. For example, when the integrated likelihood of a processing target pixel is Di(tx, ty), the skin color likelihood thereof is Dc(tx, ty), and the difference value thereof is Dm(tx, ty), the integrated likelihood Di(tx, ty) thereof is expressed by Expression 2 below.

Di(tx,ty)=w×Dc(tx,ty)+(1−w)×Dm(tx,ty) (2)

As described above, as the distance between a pixel (px, py) in the search region and the position of the tracking target object in the past increases, the weight factor w of the skin color likelihood Dc(tx, ty) decreases, and the weight factor (1−w) of the difference value Dm(tx, ty) increases. Thus, if it is assumed that the tracking target object is present at the position of the pixel (px, py), the skin color likelihood Dc(tx, ty) is weighted more when the moving speed of the tracking target object is small, and the difference value Dm(tx, ty) is weighted more when the moving speed of the tracking target object is large.

Description is continued by returning to FIG. 1. The detector 30 detects the position of a pixel whose integrated likelihood exhibits the local maximum value among the respective pixels in the above-described search region as a candidate position of the tracking target object. In the first embodiment, the detector 30 determines whether the integrated likelihood of a central pixel of each of the pixel blocks having a matrix form of i rows (i≧1) by j columns (j≧1) with respect to a plurality of pixels included in the above-described search region exhibits a larger value than the integrated likelihoods of the surrounding pixels. Moreover, when the integrated likelihood of the central pixel of the pixel block exhibits a larger value than the integrated likelihoods of the surrounding pixels, the detector 30 determines that the integrated likelihood of the central pixel exhibits the local maximum value and detects the central pixel as the candidate position of the tracking target object. In this way, the detector 30 detects m (m≧1) candidate positions among the respective pixels in the above-described search region. In addition, by performing processing such as Gaussian filtering on the integrated likelihoods of the respective pixels in the above-described search region as necessary, it becomes easy to track a region where high integrated likelihoods are distributed over a wide range. Moreover, by eliminating points where the integrated likelihood is locally increased due to noise included in an image, it is possible to detect local maximum points more stably.

The determining unit 40 determines the position of the tracking target object based on predetermined criteria from the candidate positions detected by the detector 30. In the first embodiment, the determining unit 40 selects a candidate position in which the integrated likelihood exhibits the largest value among the m candidate positions detected by the detector 30. Moreover, when the value of the integrated likelihood corresponding to the pixel at the selected candidate position exceeds a threshold value, the determining unit 40 determines the candidate position as the position of the tracking target object. When the value of the integrated likelihood is equal to or smaller than the threshold value, tracking ends by regarding tracking as failure. When tracking fails, tracking may be continued for a predetermined number of frames rather than ending tracking directly. In addition, when one candidate position is detected by the detector 30 (when m=1), and the value of the integrated likelihood corresponding to the pixel at the candidate position exceeds the threshold value, the candidate position may be determined as the position of the tracking target object. For example, when the value of the integrated likelihood corresponding to the pixel at the candidate position exceeds the threshold value, the determining unit 40 may determine the candidate position as the position of the tracking target object.

Moreover, even when the value of the integrated likelihood corresponding to the pixel at the candidate position selected as described above does not exceed the threshold value, the selected candidate position (a candidate position in which the corresponding integrated likelihood exhibits the largest value among the plurality of candidate positions) may be determined as the position of the tracking target object. For example, when a plurality of candidate positions is detected by the detector 30, the determining unit 40 may determine the candidate position in which the integrated likelihood corresponding to the pixel at the candidate position exhibits the largest value as the position of the tracking target object.

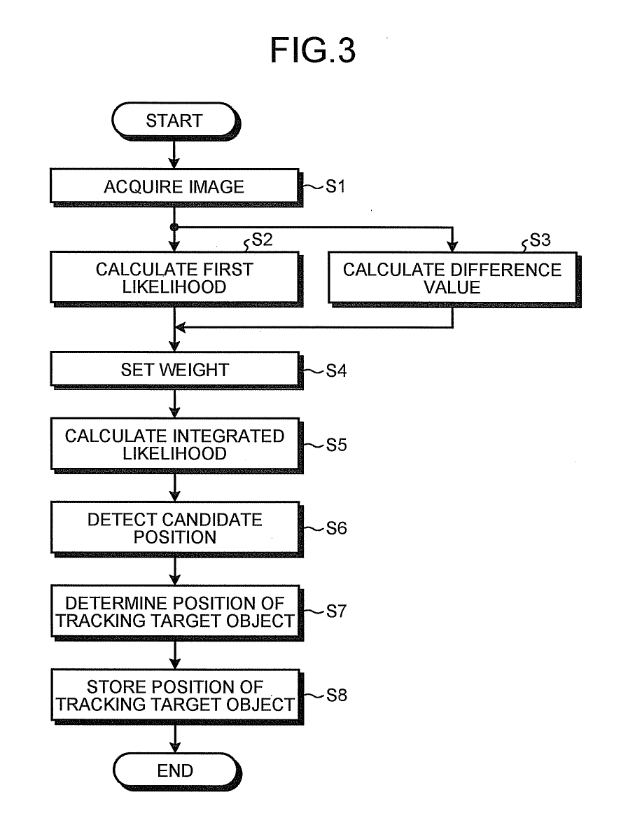

Next, an example of a processing operation performed by the tracking device 1 of the first embodiment will be described. FIG. 3 is a flowchart illustrating an example of a processing operation performed by the tracking device 1. As illustrated in FIG. 3, first, when an image in which a tracking target object (in this example, a “hand”) is photographed is acquired by the acquiring unit 10 (step S1), the first calculator 201 calculates, for each of the pixels in a search region of the acquired image, a skin color likelihood representing the degree of coincidence between the color of the pixel and the color of the hand of a person, which is the tracking target object, as the first likelihood (step S2). Moreover, the second calculator 202 calculates, for each of the pixels in the search region of the image acquired in step S1, a difference value between the pixel value of the pixel and the pixel value of the corresponding pixel in the image in a frame of the past (step S3).

Subsequently, the first setting unit 204 sets, for each of the pixels in the search region of the image acquired in step S1, the weights of the first likelihood and the difference value so that as the distance between the pixel and the position of the tracking target object in the past increases, the weight of the first likelihood decreases and the weight of the difference value increases (step S4). Subsequently, the third calculator 205 calculates, for each of the pixels in the search region of the image acquired in step S1, an integrated likelihood by weight the first likelihood and the difference value with the weights set in step S3 (step S5) and adding the weighted first likelihood and difference value. Subsequently, the detector 30 detects m (m≧1) pixels whose integrated likelihood exhibits the local maximum value among the respective pixels in the search region of the image acquired in step S1 as candidate positions (step S6). Subsequently, the determining unit 40 determines the position of the tracking target object based on predetermined criteria from the m candidate positions detected in step S6 (step S7). Subsequently, the determining unit 40 stores information such as the coordinates representing the position of the tracking target object determined in step S7 in the tracking target information storage unit 203 (step S8). In this way, information representing the position of the tracking target object in the present frame is stored in the tracking target information storage unit 203.

As described above, in the first embodiment, the weights of the first likelihood and the difference value are set so that as the distance between each of the pixels in the search region of the image acquired by the acquiring unit 10 and the position of the tracking target object in the past increases, the weight of the first likelihood (for example, the skin color likelihood) decreases and the weight of the difference value increases. Thus, when tracking the tracking target object, the first likelihood is weighted more when the moving speed of the tracking target object is small, and the difference value is weighted more when the moving speed of the tracking target object is large. In this way, it is possible to stably track the tracking target object regardless of the moving speed of the tracking target object.

### Second Embodiment

Next, a second embodiment will be described. The second embodiment is different from the first embodiment described above in that a first partial region including the candidate position detected by the detector 30 is set, and the value of the integrated likelihood of the candidate position is corrected in accordance with the degree of coincidence between the image of the first partial region and the image of the tracking target object. In the following description, the same portions as the first embodiment will be denoted by the same reference numerals, and description thereof will not be repeated.

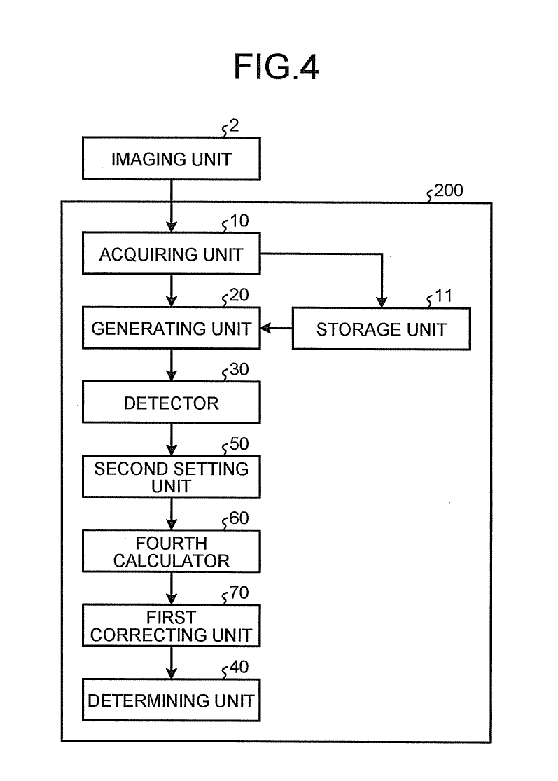

FIG. 4 is a block diagram illustrating a configuration example of a tracking device 200 according to the second embodiment. As illustrated in FIG. 4, the tracking device 200 is different from that of the first embodiment in that it further includes a second setting unit 50, a fourth calculator 60, and a first correcting unit 70.

The second setting unit 50 sets a first partial region including the candidate position detected by the detector 30 in the image acquired by the acquiring unit 10. When one candidate position is detected by the detector 30, one first partial region is set. When a plurality of candidate positions is detected by the detector 30, a plurality of first partial regions is set. That is, the same number of first partial regions as the number of the detected candidate positions is set.

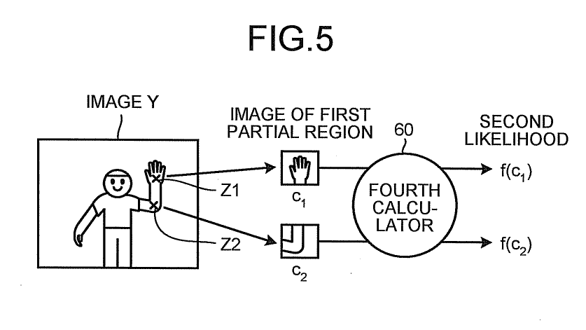

For example, it is assumed that an image Y illustrated in FIG. 5 is acquired by the acquiring unit 10, and a pixel z1 in a region corresponding to the hand of a person in the acquired image Y and a pixel z2 in a region corresponding to the arm of the person are detected as the candidate positions. In this case, the second setting unit 50 sets a first partial region C₁ including the pixel x1 and a first partial region C₂ including the pixel x2. Moreover, the second setting unit 50 cuts the images of the first partial regions C₁ and C₂ from the image acquired by the acquiring unit 10 and inputs the images to the fourth calculator 60.

The fourth calculator 60 calculates a second likelihood representing the degree of coincidence between the image of the first partial region set by the second setting unit 50 and the image of the tracking target object. When a plurality of candidate positions is detected by the detector 30, the second likelihood is calculated for each of the detected candidate positions. In the second embodiment, the fourth calculator 60 holds in advance the image of the hand of the person which is the tracking target object. Moreover, the fourth calculator 60 calculates the second likelihood representing the degree of coincidence between the image of the first partial region input from the second setting unit 50 and the image (the image of the tracking target object) of the hand held in advance. In the example of FIG. 5, the second likelihood representing the degree of coincidence between the image of the first partial region C₁ and the image of the hand is denoted by f(C₁), and the second likelihood representing the degree of coincidence between the image of the first partial region C₂ and the image of the hand is denoted by f(C₂).

A method of calculating the second likelihood is optional. For example, the second likelihood may be calculated in advance from a plurality of partial region images corresponding to the tracking target object and a plurality of partial region images corresponding to a non-tracking target object by obtaining a mistracking likelihood representing the possibility that the image of the first partial region input from the second setting unit 50 is a tracking error using a mistracking classifier generated by training using an Support Vector Machine (SVM) based on Histograms of Oriented Gradients (HOG) features, for example. For example, it is assumed that the image x of the first partial region is input to the fourth calculator 60. In this case, when a classification value of the input image x obtained by the mistracking classifier is f(x), the mistracking likelihood Df(x) may be calculated by Expression 3 below.

$$Df ( x ) = \{ \begin{matrix}1 & ( f ( x ) \geq β ) \\ \frac{f ( x )}{β - α} & ( α < f ( x ) < β ) \\ 0 & ( f ( x ) \leq α )\end{matrix} \qquad ( 3 )$$

In the second embodiment, since the fourth calculator 60 employs the value obtained by calculating (1−Df(x)) as the second likelihood, the value of the second likelihood (1−Df(x)) decreases for a candidate position having a high mistracking likelihood Df(x). In addition, the second likelihood is not limited to this, and the second likelihood may be one which represents the degree of coincidence between the image of the first partial region input from the second setting unit 50 and the image of the tracking target object.

The first correcting unit 70 corrects the value of the integrated likelihood corresponding to the pixel at the candidate position in accordance with the second likelihood calculated by the fourth calculator 60. In the second embodiment, the first correcting unit 70 corrects the value of an integrated likelihood of the candidate position detected by the detector 30 by multiplying the integrated likelihood corresponding to the pixel at the candidate position by the value of (1−Df(x)) which is the second likelihood. As described above, since the value of the second likelihood (1−Df(x)) decreases for the candidate position having a high mistracking likelihood Df(x), the value of the integrated likelihood after the correction decreases. In this way, the possibility that the candidate position corresponding to the image of the first partial region which is not similar to the image of the tracking target object is erroneously selected as the position of the tracking target object decreases.

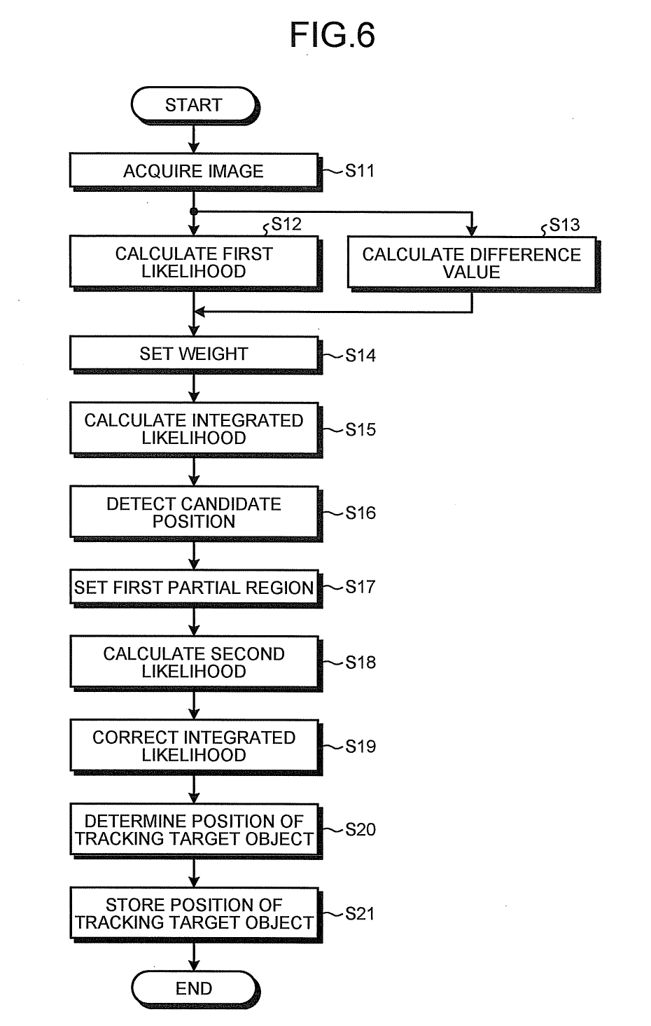

Next, an example of a processing operation performed by the tracking device 200 according to the second embodiment will be described. FIG. 6 is a flowchart illustrating an example of a processing operation performed by the tracking device 200. Since the contents of the processing of steps S11 to S16 in FIG. 6 are the same as the contents of the processing of steps Si to S6 in FIG. 3, detailed description thereof will not be repeated.

In step S17, the second setting unit 50 sets a first partial region including the candidate position detected in step S16 in the image acquired in step S11 (step S17). The image of the first partial region set in step S17 is cut from the image acquired in step S11 and input to the fourth calculator 60. The fourth calculator 60 calculates the second likelihood representing the degree of coincidence between the image of the first partial region input from the second setting unit 50 and the image of the tracking target object (step S18). Subsequently, the first correcting unit 70 corrects the value of the integrated likelihood corresponding to the pixel at the candidate position detected in step S16 in accordance with the second likelihood calculated in step S18 (step S19). Subsequently, the determining unit 40 determines the position of the tracking target object based on the value of the integrated likelihood corrected in step S19 (step S20). In the second embodiment, when a plurality of candidate positions is detected in step S16, the determining unit 40 selects a candidate position whose integrated likelihood corrected by the first correcting unit 70 exhibits the largest value. When the value of the integrated likelihood corresponding to the pixel at the selected candidate position exceeds a threshold value, the determining unit 40 determines the candidate position as the position of the tracking target object. Moreover, when one candidate position is detected in step S16, and the value of the integrated likelihood after the correction (correction by the first correcting unit 70) corresponding to the pixel at the candidate position exceeds a threshold value, the determining unit 40 determines the candidate position as the tracking target object. Moreover, the determining unit 40 stores information such as the coordinate representing the position of the tracking target object determined in step S20 in the tracking target information storage unit 203 (step S21).

As described above, in the second embodiment, even at a candidate position in which the integrated likelihood calculated by the third calculator 205 has a large value, when the second likelihood representing the degree of coincidence between the image of the first partial region including the candidate position and the image of the tracking target object has a small value (the image of the first partial region is not similar to the image of the tracking target object), the value of the integrated likelihood corresponding to the pixel at the candidate position is corrected so as to decrease. The candidate position is prevented from being erroneously selected as the position of the tracking target object.

For example, when the tracking target object is the hand of a person, and the person is wearing a short sleeve or the like, so that the arm of the person is exposed to the outside, since the arm has substantially the same color as the hand which is the tracking target object and moves similarly to the hand, there is a case where a local maximum value is observed in a region corresponding to the arm of the person within the image acquired by the acquiring unit 10. In this case, in the configuration of the first embodiment described above, it is difficult to track the hand of the tracking target object correctly. In contrast, in the second embodiment, even at a candidate position (the candidate position detected in a region corresponding to the arm of a person, for example) in which the integrated likelihood calculated by the third calculator 20 has a large value, when the second likelihood representing the degree of coincidence between the image of the first partial region including the candidate position and the image (the image of the hand) of the tracking target object has a small value, the value of the integrated likelihood corresponding to the pixel at the candidate position is corrected so as to decrease. The candidate position is prevented from being erroneously selected as the position of the tracking target object. That is, according to the second embodiment, since it is possible to distinguish a non-tracking target object which is difficult to distinguish from the tracking target object with only the integrated likelihood calculated by the third calculator 20, it is possible to track the tracking target object more stably.

### MODIFICATION EXAMPLE 1 OF SECOND EMBODIMENT

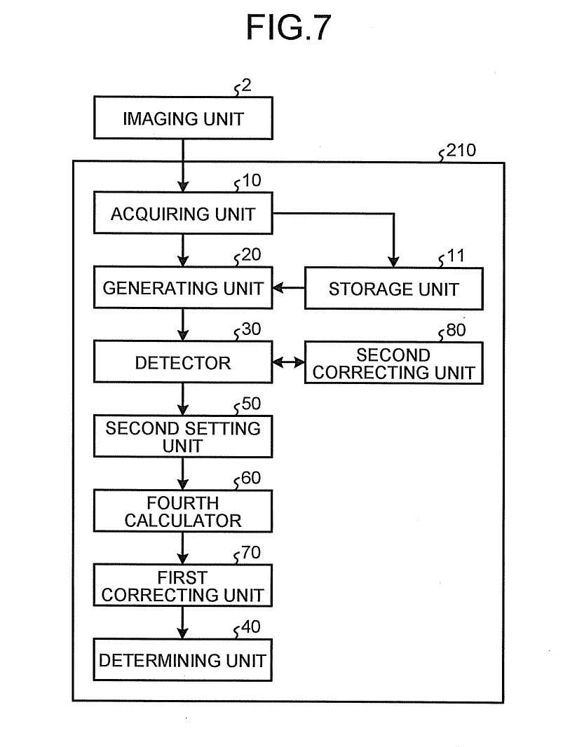

FIG. 7 is a block diagram illustrating a configuration example of a tracking device 210 according to a modification example of the second embodiment. As illustrated in FIG. 7, the tracking device 210 further includes a second correcting unit 80. The second correcting unit 80 corrects the integrated likelihoods of respective pixels in a second partial region by decreasing the values of the integrated likelihoods of respective pixels in the second partial region including the candidate positions detected by the detector 30 and at least a part of the first partial region described above by a predetermined amount. Moreover, the detector 30 detects the candidate position again after the second correcting unit 80 performs correction. In addition, the second partial region may be a region different from the first partial region described above. For example, a region smaller in area than the first partial region may be used as the second partial region. Moreover, the second partial region may be the same region as the first partial region. That is, a region including the candidate position and at least a part of the first partial region may be used as the second partial region.

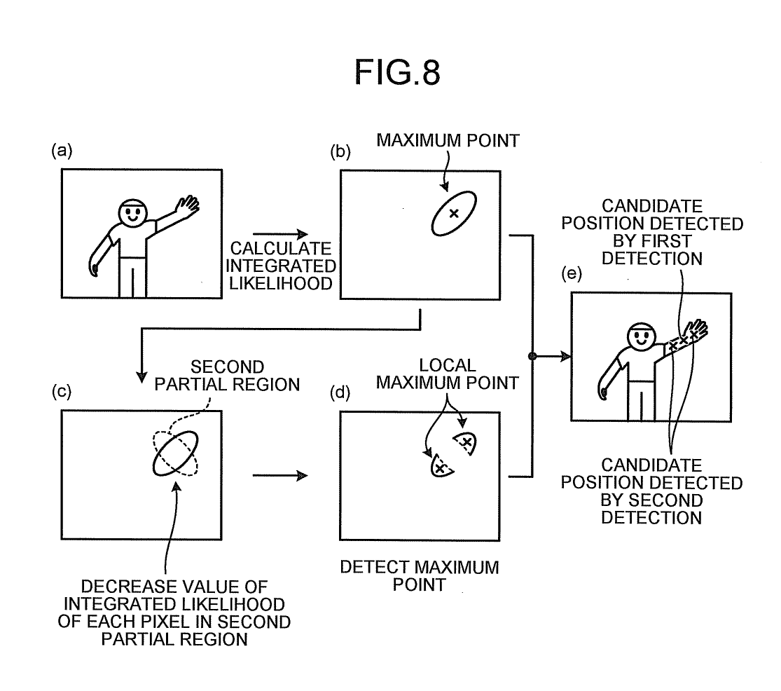

Now, it is assumed that an image illustrated in (a) of FIG. 8 is acquired by the acquiring unit 10, and as illustrated in (b) of FIG. 8B, a local maximum point is not observed in the region of each of the hand and arm of a person but the hand and arm are regarded as one object, and a local maximum point is observed at the central position thereof. In this case, since the position detected as the candidate position is different from the position of the hand of the tracking target object, the value of the second likelihood described above decreases, and there is a possibility that tracking fails. In particular, when processing such as Gaussian filtering is performed on the integrated likelihoods (or the skin color likelihoods) of the respective pixels in the search region, it becomes easy to track a region where a high integrated likelihood is distributed over a wide range. On the other hand, the possibility that the position detected as the candidate position is different from the position of the hand of the tracking target object increases.

In contrast, in the present modification example, as illustrated in (c) of FIG. 8, the second correcting unit 80 corrects the integrated likelihoods of respective pixels in a second partial region by decreasing the values of the integrated likelihoods of respective pixels in the surrounding region (the second partial region) including the candidate positions detected by the detector 30 by a predetermined amount. Moreover, the detector 30 detects the candidate position again after the second correcting unit 80 performs correction. As illustrated in (d) of FIG. 8, when a local maximum point having a sufficient integrated likelihood is detected, the local maximum point is detected as the candidate position. That is, as illustrated in (e) of FIG. 8, even when the center of a region in which a hand and an arm are continuous is detected as a candidate position by the first detecting process, by decreasing the integrated likelihoods of the respective pixels in the second partial region including the candidate position by a predetermined amount, the possibility that two local maximum points positioned with the center of the region interposed are observed by the second detecting process increases. Therefore, in the second detecting process, it is easy to detect a pixel in which the hand of the tracking target object is highly likely to be present as the candidate position.

In addition, after performing the correction by the second correcting unit 80 and the second detecting process as described above, in step S16 of FIG. 6, the flow may proceed to step S17 and the subsequent processes. Moreover, the flow may proceed directly to step S17 and the subsequent processes after step S16 (the first detecting process). Moreover, when it is determined in step S20 that tracking failed, the flow may return to step S16 to perform the correction by the second correcting unit 80 and the second detecting process, and then, step S17 and the subsequent processes may be repeated.

### MODIFICATION EXAMPLE 2 OF SECOND EMBODIMENT

In the second embodiment, when a plurality of candidate positions is detected by the detector 30, the mistracking likelihood is calculated for each of the detected candidate positions. However, in order to decrease a calculation amount (processing amount), a candidate position whose integrated likelihood is low and which is less likely to be selected as the position of the tracking target object may be excluded from the candidate positions by setting the value of the integrated likelihood thereof to 0 without calculating the mistracking likelihood thereof (without performing the correction by the first correcting unit 70). In addition, the determination as to whether or not a candidate position will be subjected to the correction by the first correcting unit 70 (the second likelihood thereof will be calculated) may be made, for example, by selecting a predetermined number of candidate positions having a large integrated likelihood among the candidate positions detected by the detector 30. Alternatively, candidate positions whose integrated likelihood exceeds a predetermined threshold value may be selected. Moreover, only candidate positions whose relative value to the maximum value of the integrated likelihoods exceeds a predetermined value may be selected.

### Third Embodiment

Next, a third embodiment will be described. The third embodiment is different from the respective embodiments described above in that the value of the integrated likelihood of the candidate position detected by the detector 30 is corrected in accordance with the degree of coincidence between the moving speed of the candidate position, which is determined in accordance with the distance between the candidate position and the position of the tracking target object in the past, and the moving speed of the tracking target object in the past, which is calculated from the history of the positions of the tracking target object. In the following description, the same portions as the respective embodiments described above will be denoted by the same reference numerals, and description thereof will be not provided appropriately.

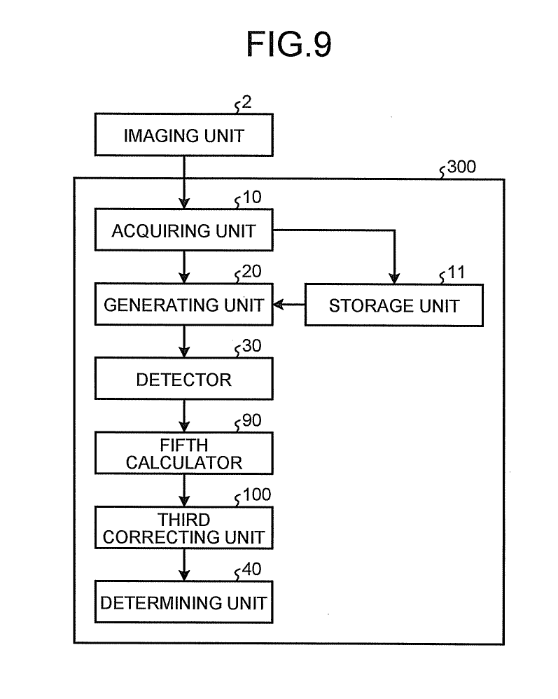

FIG. 9 is a block diagram illustrating a configuration example of a tracking device 300 according to the third embodiment. As illustrated in FIG. 9, the tracking device 300 is different from those of the respective embodiments described above in that it further includes a fifth calculator 90 and a third correcting unit 100.

The fifth calculator 90 calculates a third likelihood representing the degree of coincidence between the moving speed of a candidate position detected by the detector 30, which is determined in accordance with the distance between the candidate position and the position of the tracking target object in the past, and the moving speed of the tracking target object in the past, which is calculated from the history of the positions of the tracking target object. When a plurality of candidate positions is detected by the detector 30, the third likelihood is calculated for each of the detected candidate positions.

In the third embodiment, the fifth calculator 90 reads the position of the tracking target object in the previous frame from the tracking target information storage unit 203 and calculates the moving speed of each of the candidate positions detected by the detector 30 based on the distance between the candidate position and the position of the tracking target object in the previous frame read from the tracking target information storage unit 203. More specifically, the fifth calculator 90 regards the candidate position detected by the detector 30 as the position of the tracking target object in the present frame, detects how much the position of the tracking target object has changed between the previous frame and the present frame, and determines (calculates) the moving speed of the tracking target object in the present frame in accordance with the detection result. The determined moving speed is used as the moving speed of the candidate position.

In this example, the fifth calculator 90 calculates the moving speed of the candidate position using the position of the tracking target object in the previous frame. However, the method of calculating the moving speed is not limited to this, and the moving speed of the candidate position may be calculated using the positions of the tracking target object in several frames of the past, for example. That is, the moving speed of the candidate position may be calculated using the position of the tracking target object in the past. Moreover, the fifth calculator 90 reads the history of the additional tracking target object held in the tracking target information storage unit 203 and calculates the moving speed of the tracking target object in the past based on the read history. Moreover, the fifth calculator 90 calculates, for each of the candidate positions detected by the detector 30, the third likelihood representing the degree of coincidence between the moving speed of the candidate position and the moving speed of the tracking target object in the past.

A method of calculating the third likelihood is optional. For example, when the amount of change of the moving direction (angle) of the tracking target object in the frames of the past is Md, the amount of change of the moving speed is Ms, the value of the moving direction is Tmd, and the value of the moving speed is Tms, the third likelihood Dm may be calculated by Expression 4 below.

$$wd = \{ \begin{matrix}Md / Tmd & ( Md < Tmd ) \\ 1 & ( Md \geq Tmd )\end{matrix} \\ ws = \{ \begin{matrix}Ms / Tmd & ( Ms < Tms ) \\ 1 & ( Ms \geq Tms )\end{matrix} \\ Dm = ( 1 - cd \cdot wd ) \cdot ( 1 - ws ) \qquad ( 4 )$$

In addition, in Expression 4, when the moving speed of a candidate position regarded as the tracking target object is V and the threshold value is Tcd, “cd” is determined by Expression 5 below. When the movement of the tracking target object is small, the moving direction is not observed stably. Therefore, the third likelihood Dm is calculated using Expression 4 above, whereby when the moving speed of the tracking target object is small and “wd” is not stable, the weight of “wd” is decreased.

$$cd = \{ \begin{matrix}V / Tcd & ( V < Tcd ) \\ 1 & ( V \geq Tcd )\end{matrix} \qquad ( 5 )$$

The third likelihood Dm exhibits a large value as the degree of coincidence between the moving speed of the candidate position and the moving speed of the tracking target object in the past increases while exhibiting a small value as the degree of coincidence between the moving speed of the candidate position and the moving speed of the tracking target object in the past decreases. Moreover, the third correcting unit 100 corrects the value of the integrated likelihood in accordance with the third likelihood calculated by the fifth calculator 90 for each of the candidate positions detected by the detector 30. In the third embodiment, the third correcting unit 100 corrects, for each of the candidate positions, the value of the integrated likelihood by multiplying the integrated likelihood of the candidate position by the value of the third likelihood Dm. For example, as for the candidate position of which the third likelihood Dm has a large value, the value of the integrated likelihood after the correction is increased. That is, since the value of the integrated likelihood after the correction increases as the candidate position has a moving speed closer to the moving speed of the tracking target object in the past, the possibility that the candidate position is selected as the position of the tracking target object increases.

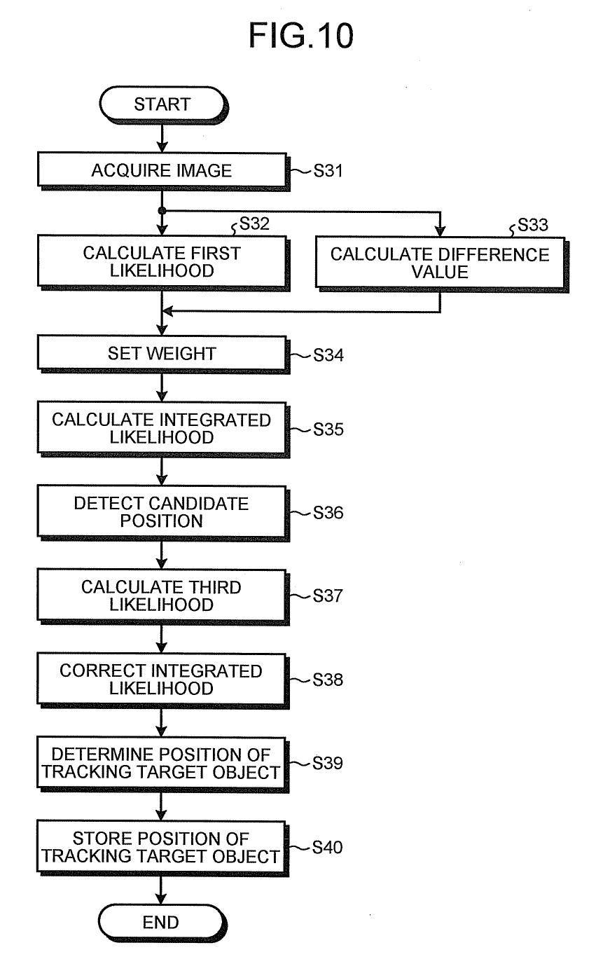

Next, an example of a processing operation performed by the tracking device 300 according to the third embodiment will be described. FIG. 10 is a flowchart illustrating an example of a processing operation performed by the tracking device 300. Since the contents of the processing of steps S31 to S36 in FIG. 10 are the same as the contents of the processing of steps Si to S6 in FIG. 3, detailed description thereof will be not provided.

In step S37, the fifth calculator 90 calculates a third likelihood representing the degree of coincidence between the moving speed of a candidate position, which is detected in step S36 determined in accordance with the distance between the candidate position, and the position of the tracking target object in the past and the moving speed of the tracking target object in the past, which is calculated from the history of the positions of the tracking target object (step S37). Subsequently, the third correcting unit 100 corrects the value of the integrated likelihood corresponding to the pixel at the candidate position detected in step S36 in accordance with the third likelihood calculated in step S37 (step S38). Subsequently, the determining unit 40 determines the position of the tracking target object based on the value of the integrated likelihood corrected in step S38 (step S39). In the third embodiment, when a plurality of candidate positions is detected in step S36, the determining unit 40 selects a candidate position whose integrated likelihood after the correction by the third correcting unit 100 exhibits the largest value. When the value (the value of the integrated likelihood after the correction) of the integrated likelihood corresponding to the pixel at the selected candidate position exceeds a threshold value, the determining unit 40 determines the candidate position as the position of the tracking target object. Moreover, when one candidate position is detected in step S36, and the value of the integrated likelihood after the correction (corrected by the third correcting unit 100) corresponding to the pixel at the candidate position exceeds a threshold value, the determining unit 40 determines the candidate position as the tracking target object. Moreover, the determining unit 40 stores information such as the coordinate representing the position of the tracking target object determined in step S39 in the tracking target information storage unit 203 (step S40).

As described above, in the third embodiment, the third likelihood described above is calculated for each of the candidate positions detected by the detector 30, and the value of the integrated likelihood is corrected in accordance with the calculated third likelihood. In this way, it is possible to determine the position of the tracking target object by taking the continuity of the moving speed of the tracking target object into consideration. Therefore, according to the third embodiment, it is possible to track the tracking target object more stably even when it is difficult to track the tracking target object correctly in the first and second embodiments.

### MODIFICATION EXAMPLE OF THIRD EMBODIMENT

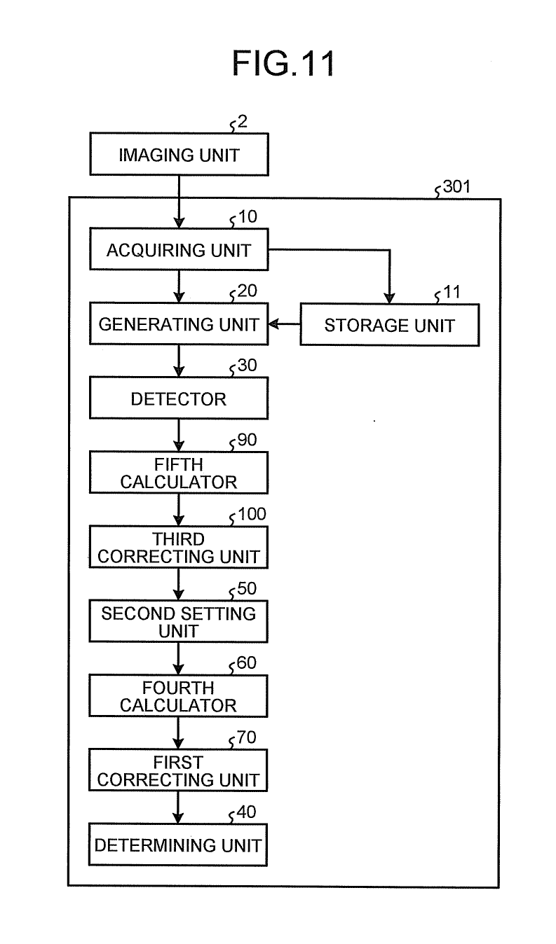

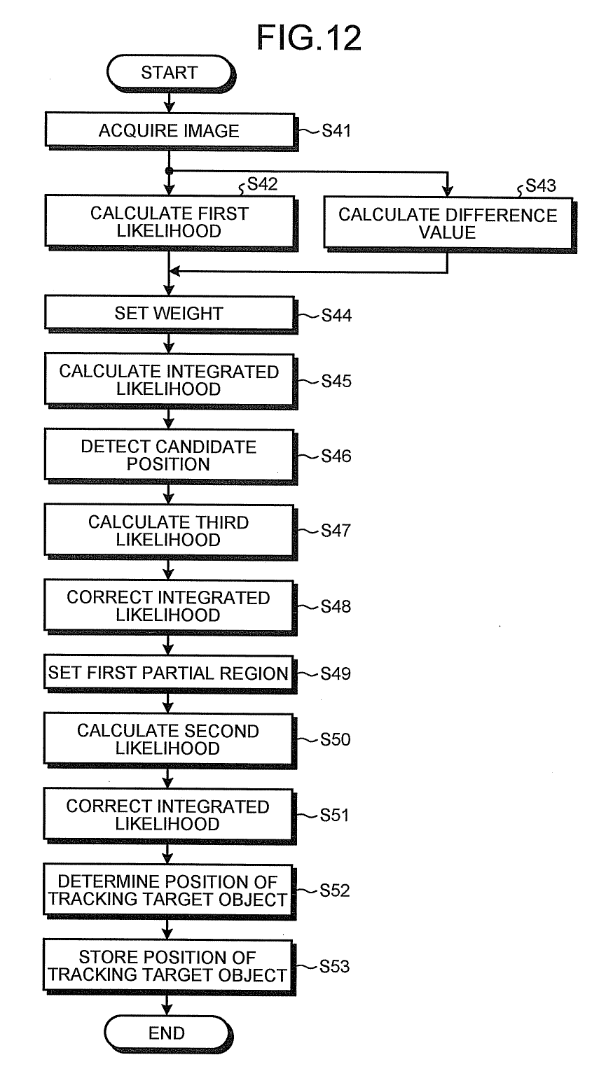

For example, the configuration of the third embodiment and the configuration of the second embodiment may be combined. FIG. 11 is a block diagram illustrating a configuration example of a tracking device 301 of this case. As illustrated in FIG. 11, the tracking device 301 further includes the second setting unit 50, the fourth calculator 60, and a first correcting unit 70 in addition to the configuration of the third embodiment described above. FIG. 12 is a flowchart illustrating an example of a processing operation performed by the tracking device 301. The contents of the processing of steps S41 to S48 in FIG. 12 are the same as the contents of the processing of steps S31 to S38 in FIG. 10. Moreover, the contents of the processing of steps S49 to S51 in FIG. 12 are the same as the contents of the processing of steps S17 to S19 in FIG. 6. That is, in the case of this modification example, the value of the integrated likelihood of each of the candidate positions detected in step S46 in FIG. 12 is corrected by the third correcting unit 100 (step S48), and is then corrected by the first correcting unit 70 (step S51). Moreover, the determining unit 40 determines the position of the tracking target object based on the value of the integrated likelihood after the correction in step S51 (step S52), and stores information such as the coordinate representing the determined position of the tracking target object in the tracking target information storage unit 203 (step S53).

In the respective embodiments described above, although the color value representing the color of a pixel is employed as an example of the pixel value, the pixel value is not limited to this. When the tracking target object is captured using an ultraviolet camera, for example, a parameter representing a calorific value of a pixel, a reflectance, or the like may be employed as the pixel value. That is, the pixel value may represent the feature of a pixel, and the kind thereof is optional. Moreover, a plurality of kinds of pixel values may be calculated for each pixel, and a plurality of kinds of likelihoods representing the possibility that the tracking target object is present in the pixel may be calculated based on the extracted pixel values. After that, the integrated likelihood may be calculated by integrating the plurality of kinds of likelihoods and the difference value while changing the weights thereof in accordance with the distance from the position of the tracking target object in the frames of the past.

Moreover, in the respective embodiments described above, although the hand of a person is employed as the tracking target object, the present invention is not limited to this, and the kind of the tracking target object is optional. For example, the face of a person or the like may be employed as the tracking target object.

Furthermore, in the respective embodiments described above, a predetermined range around the position where the “hand” which is the tracking target object is present in a frame of the past within the image acquired by the acquiring unit 10 is set as the “search region”. The search region is not limited to this, and for example, the entire image acquired by the acquiring unit 10 may be set as the search region.

Hardware Configuration and Program

A command generating device according to the respective embodiments and respective modification examples described above has a hardware configuration using a general computer which includes a control device such as a central processing unit (CPU), a storage device such as ROM or RAM, an external storage device such as a HDD or a SSD, a display device such as a display, an input device such as a mouse or a keyboard, and a communication device such as a communication I/F. The functions of the respective units described above are realized by the CPU of the tracking device expanding the programs stored in ROM or the like onto RAM and executing the programs. Moreover, the present invention is not limited to this, and at least a part of these functions may be realized as individual circuits (hardware).

Moreover, the program executed by the command generating device according to the respective embodiments and respective modification examples described above may be stored on a computer connected to a network such as the Internet and provided by being downloaded through the network. Furthermore, the program executed by the command generating device according to the respective embodiments and respective modification examples described above may be provided or distributed through a network such as the Internet. Furthermore, the program executed by the command generating device according to the respective embodiments and respective modification examples described above may be provided in a state of being stored in advance in ROM or the like. Furthermore, the tracking device of the present embodiment is not limited to a personal computer (PC) but may be applied to a TV or the like as long as it includes a control device such as a CPU and a storage device and processes an image acquired by an imaging device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A tracking device comprising:
an acquiring unit configured to image a tracking target object to acquire an image in units of time-sequential frames;
a first calculator configured to calculate a first likelihood representing a degree of coincidence between a pixel value of each of pixels included in a search region within the image, in which the tracking target object is to be searched for and a reference value representing a feature of the tracking target object;
a second calculator configured to calculate a difference value representing a difference between the pixel value of each of the pixels in the search region and the pixel value of a corresponding pixel in an image of a frame of the past;
a first setting unit configured to set weights of the first likelihood and the difference value so that as a distance between each of the pixels in the search region and a position of the tracking target object in the past increases, the weight of the first likelihood decreases and the weight of the difference value increases;
a third calculator configured to calculate an integrated likelihood of each of the pixels in the search region by weight the first likelihood and the difference value with the weights and adding the weighted first likelihood and difference value;
a detector configured to detect a position of a pixel whose integrated likelihood exhibits a local maximum value among the pixels in the search region as a candidate position of the tracking target object; and
a determining unit configured to determine the position of the tracking target object from the candidate position based on a predetermined criterion.

2. The device according to claim 1, further comprising:
a second setting unit configured to set a first partial region including the candidate position;
a fourth calculator configured to calculate a second likelihood representing a degree of coincidence between an image of the first partial region and an image of the tracking target object; and
a first correcting unit configured to correct a value of the integrated likelihood corresponding to a pixel at the candidate position in accordance with the second likelihood calculated by the fourth calculator,
wherein the determining unit determines the position of the tracking target object based on the corrected value of the integrated likelihood after the correction by the first correcting unit.

3. The device according to claim 2, further comprising
a second correcting unit configured to decrease a value of the integrated likelihood of each of pixels in a second partial region including the candidate position and at least a part of the first partial region by a predetermined amount to thereby correct the integrated likelihood of each of the pixels in the second partial region,
wherein the detector detects the candidate position again after the second correcting unit performs the correction.

4. The device according to claim 1, further comprising:
a fifth calculator configured to calculate a third likelihood representing a degree of coincidence between a moving speed of the candidate position, which is determined in accordance with a distance between the candidate position and the position of the tracking target object in the past, and a moving speed of the tracking target object in the past, which is calculated from a history of the position of the tracking target object; and
a third correcting unit configured to correct the value of the integrated likelihood corresponding to the pixel at the candidate position in accordance with the value of the third likelihood,
wherein the determining unit determines the position of the tracking target object based on the corrected value of the integrated likelihood after the correction by the third correcting unit.

5. The device according to claim 1,
wherein when the value of the integrated likelihood corresponding to the pixel at the candidate position exceeds a threshold value, the determining unit determines the candidate position as the position of the tracking target object.

6. The device according to claim 1,
wherein when there is a plurality of candidate positions, the determining unit determines a candidate position of a pixel whose integrated likelihood exhibits a largest value among the plurality of candidate positions as the position of the tracking target object.

7. The device according to claim 1,
wherein the pixel value is a color value representing a color of the pixel, and
wherein the reference value is a color distribution of the tracking target object.

8. A tracking method comprising:
imaging a tracking target object to acquire an image in units of time-sequential frames;
calculating a first likelihood representing a degree of coincidence between a pixel value of each of pixels included in a search region within the image, in which the tracking target object is to be searched for and a reference value representing a feature of the tracking target object;
calculating a difference value representing a difference between the pixel value of each of the pixels in the search region and the pixel value of a corresponding pixel in an image in a frame of the past;
setting weights of the first likelihood and the difference value so that as a distance between each of the pixels in the search region and a position of the tracking target object in the past increases, the weight of the first likelihood decreases and the weight of the difference value increases;
calculating an integrated likelihood of each of the pixels in the search region by weight the first likelihood and the difference value with the weights and adding the weighted first likelihood and difference value;
detecting a position of a pixel whose integrated likelihood exhibits a local maximum value among the pixels in the search region as a candidate position of the tracking target object; and
determining the position of the tracking target object from the candidate position based on a predetermined criterion.

9. A computer program product having a computer-readable medium including programmed instructions, wherein the instructions, when executed by a computer, cause the computer to execute:
imaging a tracking target object to acquire an image in units of time-sequential frames;
calculating a first likelihood representing a degree of coincidence between a pixel value of each of pixels included in a search region within the image, in which the tracking target object is to be searched for and a reference value representing a feature of the tracking target object;
calculating a difference value representing a difference between the pixel value of each of the pixels in the search region and the pixel value of a corresponding pixel in an image in a frame of the past;
setting weights of the first likelihood and the difference value so that as a distance between each of the pixels in the search region and a position of the tracking target object in the past increases, the weight of the first likelihood decreases and the weight of the difference value increases;
calculating an integrated likelihood of each of the pixels in the search region by weight the first likelihood and the difference value with the weights and adding the weighted first likelihood and difference value;
detecting a position of a pixel whose integrated likelihood exhibits a local maximum value among the pixels in the search region as a candidate position of the tracking target object; and
determining the position of the tracking target object from the candidate position based on a predetermined criterion.
